(19) United States
(12) Patent Application Publication
(10) Pub. No.: US 2011/0048696 A1
(43) Pub. Date: Mar. 3, 2011

(54) GAS-LIQUID SEPARATOR

(75) Inventor: Sverre Thomas Holte, Sandvika (NO)

(73) Assignee: STATOIL ASA, Stavanger (NO)

(21) Appl. No.: 12/864,595

(22) PCT Filed: Feb. 6, 2008
(86) PCT No.: PCT/EP2008/000905

§ 371 Date: Oct. 26, 2010

(51) Int. Cl. E21B 43/00; B01D 19/00

(52) U.S. Cl. 166/105.5; 96/195

(57) ABSTRACT

A gas-liquid separator separates free water at a downhole position of a gas well. The separator includes a centrifugal separator within a tubular portion defining a gas inlet and a gas outlet. Upstream of the centrifugal separator, the tubular portion is provided with a plurality of drain holes through which free water which was centrifugated to the tubular portion enters an annular duct allowing the collected water to flow off due to gravity. Upstream of the drain holes, a jet pump is arranged. The jet pump is driven by the gas stream to create underpressure in the duct and to suck back gas which has entered the annular duct through the drain holes. The gas-liquid separator has no moving parts and avoids monitoring or controlling of the separating process.

### FIELD OF INVENTION

The invention relates to a gas-liquid separator for separating liquid, in particular water entrained in a gas stream. The invention further relates to a gas well tubing construction comprising a gas-liquid separator.

### BACKGROUND

In natural gas production, the gas produced from a gas well often entrains free liquid, for example, water in the form of droplets. Conventionally, the liquid is removed from the gas on the surface level of the gas well before liquefying or transporting the gas.

In the field of petroleum production, it is generally known to separate gas downhole of a well in order to improve the production rate. From U.S. Pat. No. 5,431,228, a downhole gas-liquid separator is known. The separator comprises a generally helical baffle which causes the mixture of liquid and gas to rotate. Centrifugal forces thus acting on the liquid-gas flow stream cause liquid to migrate to the radial outer portion of the flow path while allowing gas to pass through a generally central portion. At the discharge end of the separator, a duct collects the gas at the central portion of the flow path and conveys it into an annular space between the production tubing and a production case surrounding the tubing. The liquid flow stream continues upwardly through the production tubing to the surface of the well in a conventional manner. The gas separated from the liquid also flows to the surface. Similar downhole liquid-gas separators are known from U.S. Pat. Nos. 6,036,749 and 6,755,250.

Accumulation of liquid at the production zone of a gas well can significantly affect the production capacity of the well since the liquid will impose an additional back-pressure on the production zone. To remove such liquid and thus to restore the flow of gas, it is known from U.S. 2005/0155769 A1 to install, downhole in the production tubing, a jet pump driven by the gas stream flowing through the production tubing to the surface of the well. The jet pump is of the venturi type and sucks liquid from the bottom of the well via a riser tube. The riser tube exits at the jet pump in a spray nozzle diffusing the liquid to a mist injected into the gas flow which thus entrains the liquid to the surface of the well. Similar jet pump constructions for use in a gas or oil well are known from U.S. Pat. No. 6,250,384 B1 or U.S. Pat. No. 4,171,016 or Patent Application Publication U.S. 2004/0129428 A1 or GB 2 422 159 A.

It is an object of the invention to provide a gas-liquid separator for separating free liquid from a gas stream without necessitating moving parts and with mininum or no need for monitoring or controlling the separation process.

### SUMMARY

According to the invention, the gas-liquid separator comprises:

a tubular portion having a circumferential wall which defines a gas inlet and a gas outlet at an axial distance from the gas inlet;

a centrifugal separator arranged coaxially within the tubular portion axially between the gas inlet and the gas outlet;

a duct provided outside the tubular portion;

at least one drain channel extending through the circumferential wall of the tubular portion adjacent to a gas outlet region of the centrifugal separator, wherein the at least one drain channel connects a liquid-collecting inner surface of the circumferential wall at the gas outlet region of the centrifugal separator with the interior of the duct; and

suction means having at least one suction port connected to the duct to create underpressure in the duct and to suck off gas from the duct.

The centrifugal separator causes the gas stream flowing through the tubular portion to rotate or swirl around the axis of the tubular portion. Since the density of the liquid droplets is higher than that of the gas, the droplets are forced radially outwards and are collected at the inner surface of the circumferential wall while the gas flowing through the tubular portion concentrates in the center area of the tubular portion. The liquid collected on the circumferential wall flows through the at least one drain channel into the duct where the liquid flows off preferably under the influence of gravity only.

The suction means creates underpressure, i.e., gas pressure which is less than the gas pressure within the tubular portion at the gas outlet region of the centrifugal separator. The underpressure enables efficient flow of liquid through the at least one drain channel into the duct while sucking off the gas from the duct.

In a preferred embodiment, the suction means is a jet pump, also known as a venturi-type ejector. The jet pump, which can be of conventional design, is arranged within the tubular portion such that the jet pump is driven by gas flowing in the tubular portion. The jet pump is arranged axially between the at least one drain channel and the gas outlet of the tubular portion and has its at least one suction port connected to the duct to create underpressure in the duct and to suck off the gas from the duct. Since, during operation of the gas-liquid separator, not only liquid exits through the at least one drain channel into the duct, but also some portion of the gas even if the cross-section of the drain channel is small, the jet pump avoids gas losses by re-entering this gas into the main gas stream. The jet pump can be of conventional design. The axis of the jet pump may extend in any direction between vertical and horizontal.

The gas-liquid separator is of simple design and removes free liquid from a gas stream both in horizontal or vertical arrangement. The separator has no moving parts and has a small size both in length and diameter. In operation, there is only a small pressure drop in gas pressure between the gas inlet-A—and the gas outlet of typically 0.1 to 0.2 bar. Through the design of the gas-liquid separator, the underpressure created by the jet pump has to be balanced by dimensioning the liquid drain channels and dimensioning the jet pump suction ports.

The flow rate and the suction rate of the jet pump may easily be adapted to the flow rate of the gas in the tubular portion and the liquid flow rate. The liquid flow rate can be adapted by suitably dimensioning the centrifugal separator and the drain channels associated therewith. Tests have shown that there is practically no gas pressure limitation. The gas pressure in the tubular portion may range, for example, from 20 to 80 bar. Contrary to prior art gas-liquid separators, the separator according to the invention is less dependent on a change in density difference between gas density and liquid density.

The tubular portion, the jet pump and the centrifugal separator are preferably mounted to form one unit. As can easily be understood, the jet pump and the centrifugal separator can also be independently placed constructional parts connected to each other via a gas pipe. Further, it can easily be understood that also a suction means other than a jet pump can be used, for example, a motor-driven pump.

Preferably, the duct comprises a duct portion extending downwards from the at least one drain channel to allow flowing off of separated liquid due to gravity only, in particular, if gas which has escaped through the at least one drain channel into the duct is allowed to flow upwards, for example, towards the surface of a gas well.

In a preferred embodiment, the duct is an annular duct formed radially between the circumferential wall and a tubular casing which coaxially surrounds the circumferential wall at a radial distance thereto. More preferably, a plurality of drain channels are provided in at least one row, the drain channels being spaced from each other within the row around the circumference of the circumferential wall. To minimize the area not covered by drain channels, a plurality of rows are provided and the drain channels of adjacent rows are staggered in the circumferential direction with respect to drain channels of an adjacent row. To further enhance the flow rate of collected liquid, the drain channels are preferably formed as elongated slots provided with their longitudinal direction transverse to a helical line defined by the at least one helical baffle of the centrifugal separator. The length of the elongated slots and the inclination of their longitudinal direction relative to the helical line are chosen in dependence on the difference between the gas pressure in the duct and the inlet pressure of the tubular portion.

The centrifugal separator preferably comprises at least one stationary helical baffle. The helical baffle may be segmented along its helical line, but is preferably a continuous baffle along this line. Preferably, a plurality of helical baffles are arranged staggered in axial direction to enhance the swirl motion of the gas stream.

The helical baffles may extend from the center of the tubular portion up to its circumferential wall. In a preferred embodiment, the at least one helical baffle surrounds a central free space which extends throughout the centrifugal separator and is accessible from the gas inlet and the gas outlet of the tubular portion. This allows introduction of tools and the like, even if the gas-liquid separator is mounted within a tubing string without demounting the separator from the string.

The gas-liquid separator as described above is primarily intended for use in a gas well and, in particular, a gas well producing no or at least a marginal amount of condensate. It should be clear that the gas-liquid separator may be used in other technical fields in which a need for separating free liquid from a gas stream flowing under pressure exists. The liquid may be water which is to be removed for dehydrating the gas stream, but may also be any other kind of liquid.

Under a second aspect, the invention relates to a gas well tubing construction, in particular the tubing construction of a gas well producing no or only a marginal amount of condensate. To provide a safeguard against free water, the gas well tubing construction comprises:

a production casing;

a production tubing provided within the production casing; and

at least the tubular portion, the centrifugal separator and the at least one drain channel associated with the centrifugal separator of at least one gas-liquid separator as described above,

wherein the at least one gas-liquid separator is arranged to separate water entrained by gas flowing upwards through the production tubing, and wherein the tubular portion is arranged downhole in the production tubing.

The water may be pumped to the surface level of the well, but is preferably re-injected down to the water reservoir of the well. The water can be re-injected in a separate part of the well, e.g., a pilot hole below a gas production zone, so that the water outlet port of the gas-liquid separator is to be connected via a crossover conduit to the re-injection area, but it is also possible to re-inject the water through a perforated liner extending from the production casing down to the production zone.

Preferably, the tubular portion of the gas-liquid separator is a constructional part of a string of the production tubing in order not to restrict the diameter of the production tubing while the duct is placed in the annular space in between the production tubing and the production casing. To make replacement easier, in another preferred embodiment, the gas-liquid separator can be dimensioned to be movable within and along the production tubing. Thus, the gas-liquid separator can be replaced without removing the production tubing. Further, existing gas wells can be provided with a gas-liquid separator according to the invention.

At least the tubular portion and the centrifugal separator and the at least one drain channel associated therewith is provided downhole the tubing construction. The suction means may be incorporated into the downhole unit, but can also be provided on the surface level using the annular space between the production liner and the production tubing as a duct through which gas which has escaped through the drain channel or drain channels can flow to the surface level of the gas well.

The water-separating portion of the gas-liquid separator is preferably placed at a height of more than 20 m, for example, 40 to 50 m above the production zone of the gas well. Placing the gas-liquid separator high above the production zone will give the water a high pressure at the reservoir depth for re-injecting. Preferably, the gas-liquid separator is placed close to a safety valve of the gas well, i.e., high up in the well to increase the water pressure for re-injection considerably.

In a preferred embodiment, a plurality of gas-liquid separators are arranged one behind the other in the production tubing to enhance the separation rate of the water. The gas-liquid separators may be individually adapted to the pressure and flow conditions at the position at which they are mounted in the production tubing.

Preferred embodiments of the gas-liquid separator and a gas well tubing construction according to the invention will now be described with reference to the accompanying drawings.

### BRIEF DESCRIPTION OF THE DRAWINGS

In the drawings:

FIG. 1 is a sectional view of a gas well tubing construction having a gas-liquid separator;

FIG. 2 is a sectional view showing the gas-liquid separator of FIG. 1 in more detail; and

FIG. 3 is a sectional view of another embodiment of a gas well tubing construction.

### DETAILED DESCRIPTION OF THE PREFERRED EMBODIMENT(S)

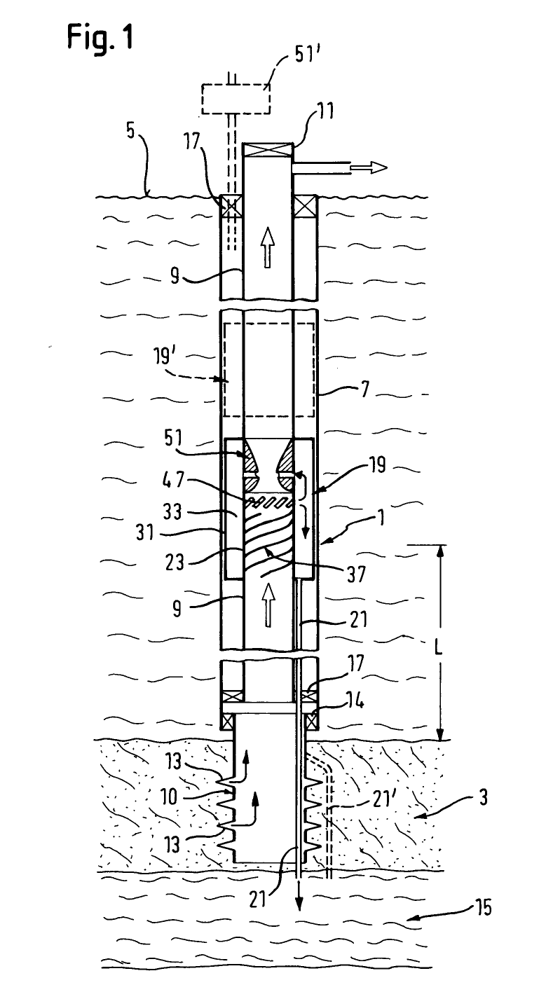

FIG. 1 shows a gas well tubing construction 1 within a well bore, for example, a sub-sea well bore, which extends from a gas production zone 3 up to a surface level 5. The tubing construction comprises a conventional production casing 7 and a production tubing 9 extending in a string form from a perforated production liner 10 at the production zone 3 up to a well head 11 above the surface level 5. The production liner 10 is provided with perforations 13 to allow entry of produced gas and is mounted to the downhole end of the production casing 7 by means of a hanger 14. Underneath the production zone 3, there is a water reservoir 15. The production tubing 9 is sealed from the production casing 7 by means of production packers 17.

In the embodiment of FIG. 1, the gas is produced under natural pressure. Further, it is assumed that the gas produces no condensate and, therefore, no condensate-water separation is required.

The gas stream travelling upwards entrains free water in the form of small droplets. To separate the water from the gas stream, a gas-liquid separator 19 is positioned downhole within the production tubing 9 at a distance L above the production zone 3. The gas-liquid separator 19 separates at least partially the water from the gas stream and re-injects the water via a liquid return pipe 21 back into the water reservoir 15 underneath the production zone 3. The liquid return pipe 21 is arranged within the annular space between the production tubing 9 and the production liner 7 and extends through the lower production packer 17 and the perforated production liner 10 down to the water reservoir 5. As indicated at 21′, the liquid return pipe can also cross the production liner 10 to re-inject the separated water in a separate part of the well, for example, a pilot hole (not shown) at the depth of the water reservoir 15.

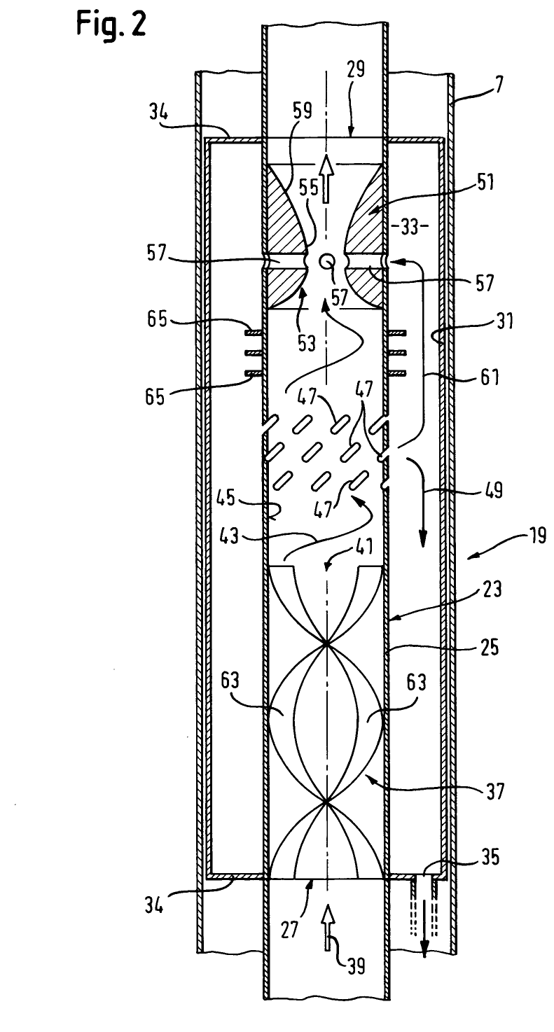

FIG. 2 shows details of the gas-liquid separator 19. The gas-liquid separator 19 comprises a tubular portion 23 the circumferential wall 25 of which has a circular cross-section and defines a gas inlet 27 and a gas outlet 29 at an axial distance above the gas inlet 27. A tubular casing 31 which coaxially surrounds the circumferential wall 25 forms in between an annular space or duct 33 which is closed at axially both ends by end walls 34 and, at its lower end, has an outlet port 35 to be connected to the liquid return pipe 21.

Above the gas inlet 27, the wall 25 encloses a centrifugal separator 37 guiding the axial gas flow (arrow 39) at the gas inlet 27 into a rotating gas flow at a gas outlet region 41 of the separator 23 as indicated by an arrow 43. Due to the rotating gas flow, free water droplets entrained in the gas stream are centrifugated towards an inner surface 45 of the wall 25 while the less dense gas portion of the gas stream continues travelling upwards in the center region of the tubular portion 23. At a short distance above the outlet region 41 of the separator 37, the inner surface 45 of the circumferential wall 25 is provided with a plurality of elongated slots or holes 47 which extend through the wall 25 and form drain channels leading water which was pushed to the inner surface 45 by the spinning motion of the gas stream through the wall 25 into the annular duct 33. As indicated at 49, the collected water flows through an approximately vertical portion of the duct 33 down to the outlet port 35 due to gravity.

At a defined distance above the holes 47, a venturi-type ejector or jet pump 51 is arranged within the tubular portion 23. The jet pump 51 is of conventional construction and has, at its entrance, a nozzle portion 53 accelerating the gas stream at a neck portion 55 provided with a plurality of suction ports 57 spaced from each other in circumferential direction. A diffuser of the jet pump 51 is shown at 59. The suction ports 57 are open to the annular duct 33 to provide negative pressure (underpressure) within the duct 33 related to the pressure at the outlet region 41 of the separator 23. The jet pump 51 thus sucks gas which has entered the annular duct 33 via the holes 47 back into the tubular casing 23 for transporting to the well head 11 , as indicated by an arrow 61. Since the jet pump 51 reintroduces gas escaped through the holes 47, losses of gas are low. Further, the difference of gas pressure at the gas inlet 27 and the gas outlet 29 is also small.

The centrifugal separator 37 comprises two stationary helical baffles adjacent to the inner surface 45 of the circumferential wall 25. The baffles 63 have a radial width which is less than the inner radius of the tubular portion 23 so that the baffles 63 wind around a central free space the diameter of which is approximately equal to the inner diameter of the neck 55 of the jet pump 51. Thus, the separator 19 has a through-going channel through which tools or the like can pass, even if the separator 19 is mounted within the production tubing 9.

The pitch and the width of the helical baffles 63 as well as the axial distance between the holes 47 and the outlet region 41 are adapted to ensure that the free water entrained in the gas stream reaches the inner surface 45 at the position of the holes 47.

The holes 47 are arranged in circumferential rows at equal distances from each other. To efficiently collect water which was pushed to the surface 45, the holes 47 of adjacent rows are staggered relative to each other by approximately half their circumferential interval. Further, the longitudinal direction of the elongated holes 47 is arranged transverse to a helical line defined by the helical baffles 63. FIG. 2 shows three rows of holes 47. Of course, the number of holes 47 and rows may be changed since, in principle, only one hole is sufficient.

The embodiment of FIG. 2 shows two helical baffles 63 staggered in the axial direction by half their pitch. The number of helical baffles 63 can be changed. In principle, one baffle is sufficient. While the helical baffle 63 has a constant pitch in axial direction, the pitch may also vary in axial direction in order to adapt the pitch to the gas flow velocity and the average direction of the flow.

Axially between the area of the holes 47 and the area of the suction ports 57, a plurality of baffles 65 are provided on the outer surface of the circumferential wall 25. The baffles 65 prevent water drained through the holes 47 into the annular duct 33 from creeping upwards to the suction ports 57.

The gas-liquid separator 19 forms a constructional unit with the centrifugal separator 37, the injection pump 51 and the tubular casing 31 fixedly mounted to the tubular portion 23. The tubular portion 23 and the production tubing 9 approximately have the same diameter while the outer diameter of the casing 31 is less than the inner diameter of the production casing 7. Further, the gas-liquid separator 19 forms a constructional part of the production tubing 9 and fits inside the production casing 7 so that the gas-liquid separator 19 can be retrieved together with the production tubing 9.

As shown in FIG. 1 at 19′, a plurality of gas-liquid separators can be arranged one behind the other in the production tubing 9 to improve the efficiency of water removal.

In the embodiment shown in FIG. 2, the injection pump 51 is placed in the vicinity of the centrifugal separator 23 and the duct 33 is enclosed by the tubular casing 31 and the end walls 34. These components are unnecessary if the annular space in between the production casing 7 and the production tubing 9 including the tubular portion 23 is used to form the duct 33. Since the annular space forming the duct extends up to the surface level 5 of the well, a pump can be provided also at the surface level 5 as indicated at 51′ in FIG. 1. The pump 51′ has its suction port connected to the annular space between the production liner 7 and the production tubing 9 to create underpressure in the annular space and to suck off gas therefrom. The gas may be added to the produced gas at the well head 11. If a surface-level pump 51′ is used, the jet pumps 51 are unnecessary. The surface-level pump 51′ can be associated with a plurality of gas-liquid separators arranged along the production tubing 9.

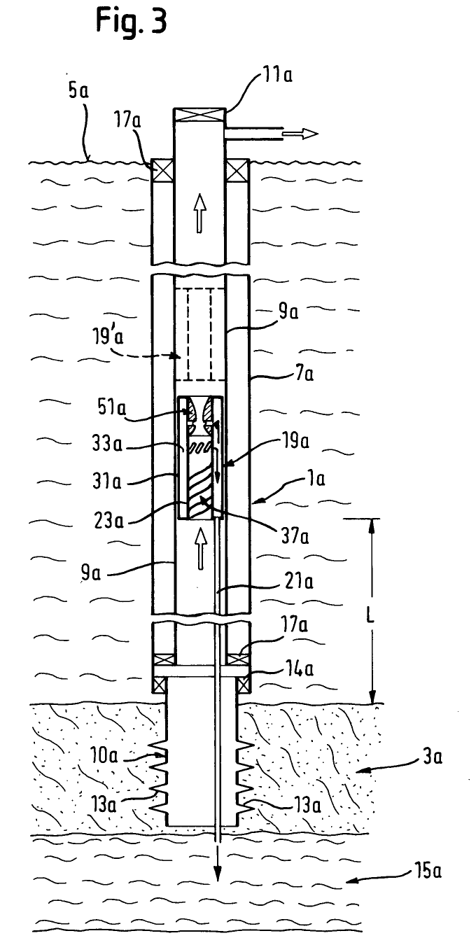

FIG. 3 shows another embodiment of a gas well tubing construction. Components of like construction and/or like function are designated with reference numerals used in FIGS. 1 and 2 with the letter “a” added for distinction. Reference is made to the description of FIGS. 1 and 2.

The gas well tubing construction la mainly differs from the construction 1 in the outer dimensions of the gas-liquid separator 19a, the tubular casing 31a of which has an outer diameter which is less than the inner diameter of the production tubing 9. Thus, the gas-liquid separator 19 can be inserted and removed along the production tubing without demounting or retrieving the production tubing 9. The water return pipe 21a preferably extends down to the water reservoir 15a inside the production tubing 9 and the perforated production liner 10a.

FIGS. 1 and 3 show vertical well bores. As can easily be understood, the well bore can also be inclined to the vertical direction as long as the water can be drained off by gravity through the annular duct and the liquid return pipe. In the embodiment of FIG. 1, the liquid return pipe 21 can also be positioned inside the production tubing 9.

While the construction and the operation of the gas-liquid separator are explained in relation to a gas well, it is clear that the separator may also be used for separating other liquids than water from a gas stream and may also be used in other industrial applications.

1. Gas-liquid separator comprising:
a) a tubular portion having a circumferential wall which defines a gas inlet and a gas outlet at an axial distance from the gas inlet;
b) a centrifugal separator arranged coaxially within the tubular portion axially between the gas inlet and the gas outlet;
c) a duct provided outside the tubular portion; and
d) at least one drain channel extending through the circumferential wall of the tubular portion adjacent to a gas outlet region of the centrifugal separator,
wherein the at least one drain channel connects a liquid-collecting inner surface of the circumferential wall at the gas outlet region of the centrifugal separator with the interior of the duct; and
e) suction means having at least one suction port connected to the duct to create underpressure in the duct and to suck off gas from the duct.

2. Gas-liquid separator as claimed in claim 1, wherein the suction means is a jet pump arranged within the tubular portion to be driven by gas flowing in the tubular portion,
wherein the jet pump is arranged axially between the at least one drain channel and the gas outlet of the tubular portion and has at least one suction port connected to the duct to create underpressure in the duct and to suck off gas from the duct.

3. Gas-liquid separator as claimed in claim 1, wherein the duct comprises a duct portion extending downwards from the at least one drain channel to allow flowing off of separated liquid due to gravity.

4. Gas-liquid separator as claimed in claim 1, wherein the at least one suction port of the jet pump is connected to the duct at a position located above the at least one drain channel.

5. Gas-liquid separator as claimed in claim 1, further comprising at least one baffle inside the duct axially in between the at least one drain channel and the at least one suction port of the suction means.

6. Gas-liquid separator as claimed in claim 1, wherein the duct is an annular duct formed radially between the circumferential wall and a tubular casing which coaxially surrounds the circumferential wall at a radial distance thereto.

7. Gas-liquid separator as claimed in claim 6, wherein a plurality of drain channels are provided in at least one row, wherein the drain channels are spaced from each other within the row around the circumference of the circumferential wall.

8. Gas-liquid separator as claimed in claim 7, wherein the drain channels are provided in a plurality of rows and the drain channels of adjacent rows are staggered in the circumferential direction with respect to the drain channels of an adjacent row.

9. Gas-liquid separator as claimed in claim 6, wherein the at least one drain channel is an elongated hole provided with its longitudinal direction transverse to a helical line defined by the at least one helical baffle of the centrifugal separator.

10. Gas-liquid separator as claimed in claim 1, wherein the centrifugal separator comprises at least one helical baffle arranged in a stationary manner within the tubular portion with its helical axis coaxial to an axis of the tubular portion.

11. Gas-liquid separator as claimed in claim 10, wherein the at least one helical baffle surrounds a central free space which extends throughout the centrifugal separator and is accessible from the gas inlet and the gas outlet of the tubular portion.

12. Gas-liquid separator as claimed in claim 11, wherein the centrifugal separator comprises a plurality of helical baffles staggered in axial direction.

13. Gas well tubing construction comprising:
a production casing;
a production tubing provided within the production casing and at least the tubular portion, the centrifugal separator and the at least one drain channel associated with the centrifugal separator of at least one gas-liquid separator as claimed in claim 1, wherein at least one gas-liquid separator is arranged to separate water entrained by gas flowing upwards through the production tubing, and wherein the tubular portion is arranged downhole in the production tubing.

14. Gas well tubing construction as claimed in claim 13, wherein the gas-liquid separator is dimensioned to be movable within and along the production tubing.

15. Gas well tubing construction as claimed in claim 13, wherein the duct is arranged in between the production tubing and the production casing.

16. Gas well tubing construction as claimed in claim 15, wherein the duct extends up to the surface level of the gas well and the suction means is arranged at the surface level.

17. Gas well tubing construction as claimed in claim 13, wherein the suction means is a jet pump provided within the tubular portion.

18. Gas well tubing construction as claimed in claim 13, wherein the gas-liquid separator is positioned at a height (L) of more than 40 m above a gas production zone of the well, preferably close to a safety valve of the well.

19. Gas well tubing construction as claimed in claim 13, wherein a plurality of gas-liquid separators are arranged one behind the other in the production tubing.
